(19) United States
(12) Patent Application Publication
(10) Pub. No.: US 2026/0006298 A1
(43) Pub. Date: Jan. 1, 2026

(54) SYSTEMS AND METHODS FOR SYNCHRONIZING DYNAMIC ACQUISITION PROTOCOLS TO VIDEO SEGMENTS

(71) Applicant: Synchrony Bank, Stamford, CT (US)

(72) Inventors: Charles Kei Ira, Stamford, CT (US); Jeremy Mack, Stamford, CT (US); Michael Storiale, Stamford, CT (US); Jennifer Cantor, Stamford, CT (US); Lisa Hammond, Stamford, CT (US)

(21) Appl. No.: 19/253,284

(22) Filed: Jun. 27, 2025

Related U.S. Application Data
(60) Provisional application No. 63/665,612, filed on Jun. 28, 2024.

(51) Int. Cl. H04N 21/658

(52) U.S. Cl. CPC H04N 21/6581

(57) ABSTRACT

A computing device may synchronize a presentation of acquisition protocols to media. The computing device may detect instructions associated with a current context of a media segment. The computing device may execute a request for an acquisition protocol for an object corresponding to the context based on the instructions. The request can include an identification of the object and a user associated with the presentation of the media. The acquisition protocol may be configured to enable access to an instance of the object. The computing device may receive the acquisition protocol and, in response, facilitate a presentation of the acquisition protocol next to the presentation of the media segment.

### CROSS-REFERENCE TO RELATED APPLICATIONS

The present patent application claims the benefit of priority to U.S. Provisional Patent Application 63/665,612 filed Jun. 28, 2024, which is incorporated herein by reference in its entirety for all purposes.

### TECHNICAL FIELD

This disclosure relates generally to generating dynamic acquisition protocols, and more particularly to synchronizing retrieval and presentation of dynamic acquisition protocols to video.

### BACKGROUND

Media, such as video or webpages, include a variety of elements to present a particular look and feel. For example, media may include instructions for defining layout, colors schemes, content, etc. In some instances, the media may include instructions for tailoring the presentation of the media to particular platforms and/or users. Tailoring the presentation of media to particular platforms and/or users may include predefining multiple versions of the media in advance along with logic to determine which version of media is to be presented to which platform and/or user. While predefining media may enable a degree of tailoring to particular platforms and/or users, predefining multiple versions of media may increase the complexity of the media (e.g., larger file sizes, increased likelihood of errors/bugs, etc.), increase storage requirements, increase bandwidth requirements, etc. In addition, there may be a limit as to the granularity in the versions of media that can be predefined. For example, it may be possible to predefine media for sets of users or platforms, but the processing, storage, and bandwidth requirements of hosting and serving the media may prevent predefining media for individual users or devices.

### SUMMARY

Methods are described herein for synchronizing a presentation of acquisition protocols to media. The methods may include detecting, during a presentation of a media segment, instructions associated with a current context being presented by the media segment; executing, based on the instructions, a request for an acquisition protocol for an object corresponding to the current context, wherein the request includes an identification of the object and a user associated with the presentation of the media segment, wherein the acquisition protocol is configured to enable access to an instance of the object; receiving the acquisition protocol; and facilitating a presentation of the acquisition protocol next to the presentation of the media segment.

The systems described herein for synchronizing a presentation of acquisition protocols to media. The systems may include one or more processors and a non-transitory computer-readable medium storing instructions that, when executed by the one or more processors, cause the one or more processors to perform any of the methods as previously described.

The non-transitory computer-readable media described herein may store instructions which, when executed by one or more processors, cause the one or more processors to perform any of the methods as previously described.

These illustrative examples are mentioned not to limit or define the disclosure, but to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 illustrates a block diagram of example video-object acquisition system configured to synchronize a presentation of dynamic acquisition protocols with video segments according to aspects of the present disclosure.

FIG. 2 illustrate an example interface configured to present video segments and dynamic acquisition protocols according to aspects of the present disclosure.

FIG. 3 illustrates an example block diagram depicting customizing a webpage to display alternative acquisition protocols according to aspects of the present disclosure.

FIG. 4 illustrates a flowchart of an example process for detecting boundaries relative to linear programming according to aspects of the present disclosure.

FIG. 5 illustrates an example computing device architecture of an example computing device that can implement the various techniques described herein according to aspects of the present disclosure.

### DETAILED DESCRIPTION

Method and systems are described herein for generating and present dynamic acquisition protocols synchronized to video. A video segment may include a representation of one or more objects. In some examples, the representation of the one or more objects may correspond to a promotion by a user (e.g., such as in a livestream, etc.). In other examples, the representation of the one or more objects may be positioned within a scene (e.g., product placement, etc.). The one or more objects can be detected and used to generate one or more dynamic acquisition protocols tailored to a user device and/or the user thereof that is presenting the video. The one or more dynamic acquisition protocols may enable acquisition of the one or more objects by the user device and/or the user thereof. In some instances, the one or more dynamic acquisition protocols may be presented in association with the presentation of the object within the video segment (e.g., such as side-by-side, etc.). In other instances, the one or more dynamic acquisition protocols maybe presented for predetermined time intervals relative to the length of the presentation of the video segment.

A user device (e.g., computing device, display device such as a television or monitor, etc.), may connect to a stream service configured to broadcast video streams that present dynamic acquisition protocols synchronized to the video stream. The video stream may be presented within an interface of the user device. In some examples, the interface may be a web-based interface (e.g., such as a browser, etc.). In other instances, the interface may be an interface of an application executing on the user device. In still yet other instances, the interface may be streamed to the display device from one or more remote sources. The video stream may include a representation of one or more objects presented within the video stream. The objects may be promoted via the video stream (e.g., such a livestream, etc.). Alternatively, or additionally, the objects may appear within the video stream (e.g., without being explicitly promoted, etc.).

The interface may present information associated with the objects represented within the video stream. For example, the interface may present an identification of the object, a description of the object, an identification of a provider of the object (e.g., such as a retailer, ecommerce platform, manufacturer, etc.), an acquisition protocol for the object (e.g., facilitated by the interface, a provider, and/or the like), an image of the object, a video of the object, combinations thereof, and/or the like. The information may be included within the video stream (e.g., such as within metadata of the video stream, etc.), within the interface, dynamically retrieved at runtime, etc.), combinations thereof, or the like.

In some instances, the video stream and/or the interface may include instructions for generating (or retrieving) dynamic acquisition protocols A dynamic acquisition protocol may be executed to enable the user device and/or the user thereof to acquire an instance of the object represented by the stream. The information associated with the objects represented within the video stream may be presented in association with the video stream such next to the video stream, over a portion of the video stream (e.g., within a pop-up window, iFrame, picture-in-picture window, or the like), or the like. In some instances, acquisition protocols may be presented separately from other information associated with the object such as in a different portion of the interface, a different window, etc.

In some examples, the instructions may be embedded within the video stream. For example, the instructions may be embedded into metadata of the video stream, encoded into one or more frames of the video stream (e.g., by modifying one or more pixels of the one or more frames, etc.), encoded into an audio channel of the video stream, etc.), embedded into the interface, combinations thereof, or the like. The instructions may execute to generate one or more acquisition protocols and present the one or more acquisition protocols within the interface. Alternatively, or additionally, the instructions may transmit a request to a remote server for the one or more acquisition protocols. The request may include, but is not limited to, an identification of objects associated with the requested acquisition protocols, an identification the user device and/or the user thereof, hardware and/or software information of the user device (e.g., hardware installed on the user device, software installed on the user device, etc.), network information of the user device (e.g., Internet Protocol (IP) address, media access control (MAC) address, etc.), a geolocation of the user device, information associated with the video stream (e.g., such as an identification of the video stream, an identification of objects of the video stream, the current position of the video stream being presented by the user device, etc.), combinations thereof, and/or the like. The remote server may generate one or more acquisition protocols based on the request and transmit a response including at least one of the one or more acquisition protocols. In some instances, the one or more acquisition protocols may be generated for the particular user device and/or user thereof based on characteristics of the user device and/or the user thereof such as, but not limited to, browsing activity, demographic information, historical resource requests, etc.)

The interface may be configured to execute the instructions at a particular time relative to the presentation of the video stream to synchronize presentation of an object with a presentation of the information associated with that object (e.g., such as acquisition protocols, etc.). For example, the video stream may include instructions scheduled to execute at approximately the same time a particular object is to be presented within the video stream. The instructions may be identified when the interface connects to the video stream. The instructions may indicate a time in which the instructions are to be executed (relative to a time or position of the video stream, etc.) to coincide with a presentation of a particular object. Alternatively, if the presentation order of the objects is known and regular, the instructions may be executed at regular time intervals (e.g., ever 10 minutes, etc.) to coincide with the presentation of each object, etc.). In some instances, the instructions may be received (within the video stream, etc.) at a particular time or position of the video stream such as when a particular object is being presented. In those instances, the instructions may be executed upon being received to retrieve the information associated with the particular object.

In other examples, interface, the user device, and/or a server may process the video stream in real time to detect objects presented within the video stream. For instance, the user device may process the video stream using a machine-learning model to detect objects within the video stream. If processed remotely (e.g., by a server or other remote device connected to the same video stream), the server (or other remote device) may transmit a communication to the user device (or directly to the interface). The communications may include an identification of the object being presented and/or the instructions enabling the user device to retrieve the information associated with the object being presented by video stream. The remote server (or other device) may begin processing the video stream at the same time the user device connects to the video stream. Alternatively, the remote server (or other remote device) may process the video stream in advance and transmit the instructions to the user device when the user device connects to the video stream. The instructions may include an indication of a time (relative to the video stream) or position of the video stream in which the instructions are to be executed.

The machine-learning model may be trained to detect objects within video frames. In some instances, the machine-learning model may be a convolutional neural network trained to detect objects within images (e.g., video frames, etc.) and/or video. In other instances, the machine-learning model may be any type of machine-learning model trained for object detection. Examples of machine-learning models include, but are not limited to, deep learning networks, neural networks, convolutional neural networks (e.g., and/or variants thereof such as, but not limited to, region-based convolution neural networks (R-CNN), faster convolution neural networks (F-CNN), faster region-based convolutional neural networks FR-CNN, and/or the like), You Only Look Once (YOLO), EfficientDet, recurrent neural networks (and/or variants thereof such as Long, Short Term Memory (LSTM), mask recurrent neural networks, etc.), transformers (such as generative pre-trained transformers (GPT), Bidirectional Encoder Representations from Transformers (BERTs), text-to-text-transfer-transformer (T5), etc.), generative adversarial networks (GANs), recurrent gated units (GRUs), combinations thereof, or the like.

The machine-learning model may be trained using supervised learning, unsupervised learning, semi-supervised learning, transfer learning, metalearning, reinforcement learning, combinations thereof, or the like using a training dataset derived from video streams and/or images of objects to be identified within video streams. The training dataset may include a representation of the particular objects to be identified, a representation of a class of objects in which a particular object to be identified is a member (e.g., a representation of cars that includes a particular car that the machine-learning model is to be configured to identify, etc.), and/or the like. If the training dataset includes limited representations of particular objects (e.g., too few to train the machine-learning model), the training dataset may be augmented with additional data associated with the particular objects. The additional data may include manually generated data associated with the particular objects, data associated with similar objects, procedurally generated data associated with the particular objects, combinations thereof, and/or the like. In some instances, such as when the machine-learning model is to be training using supervised learning techniques, labels may be added to the training dataset. The labels may be generated manually (e.g., via user input, etc.), by an already training instance of the machine-learning model, by a generative adversarial network, combinations thereof, and/or the like. The machine-learning model may be trained over a predetermined time interval, for predetermined quantity of iterations, and/or until one or more accuracy metrics are reached (e.g., such as, but not limited to, accuracy, precision, area under the curve, logarithmic loss, F1 score, a longest common subsequence (LCS) such as ROUGE-L, Bilingual evaluation Understudy (BLEU) mean absolute error, mean square error, or the like.

Dynamic acquisition protocols may include instructions, executable by the user device and/or the user thereof, for acquiring the object represented by the video stream. The acquisition protocol may include a request for a set of resources in exchange for the object. In some instances, one or more acquisition protocols may be presented. For example, a first acquisition protocols may correspond with a process for acquiring the object from a first provider and a second (dynamic) acquisition protocol may be generated in which the set of resources may be provided by another device or entity (e.g., via financing, etc.). The user device and/or the user thereof may provide a subset of the set of resources to the another device or entity over time. The user device and/or the user thereof may select between the one or more acquisition protocols or request additional acquisition protocols to enable acquisition of the object in instances when the user device and/or the user thereof have insufficient resources).

Dynamic acquisition protocols may be presented for predetermined time intervals or for time intervals based on the objects being presented. For instance, a dynamic acquisition protocol for a particular object may be presented while the particular object is being presented within the video stream. The presentation of the dynamic acquisition protocol may be terminated when the object is no longer being presented within the video stream. Alternatively, the presentation of the dynamic acquisition protocol may be replaced by a presentation of a new dynamic acquisition protocol for a new particular object when the new particular object is presented within the video stream. Alternatively, each dynamic acquisition protocol may be presented or a predetermined time interval.

In an illustrative example, a computing device may connect to a video stream. The video stream may include an entertainment program (e.g., movie, television show, etc.), advertisement, video conference, livestream, or live or recorded video segment. The computing device may connect to the video stream through a web-based interface (e.g., browser, etc.), an application associated with the video stream, a native application (e.g., an application of the computing device configured to present media), and/or the like. The computing device may then present a video segment of the video stream (e.g., one or more video frames of the video stream) in an interface configured to present additional information associated with the video segment or video stream. For example, the computing device may present the video segment within a browser configured to present information associated with the video segment or video stream next to the video segment. The computing device may begin presenting the video segment as the video stream is received, after a predetermined portion of the video stream is received by the computing device, or after the entire video stream is received by the computing device.

The computing device may detect instructions associated with a context with a current context of the video segment. A context may be a representation of a semantic state of the video segment at a given time instant. For example, in a livestream promoting one or more objects, the context at a particular time instant may correspond to the semantic state of the livestream at the particular time instant such as the promotion of a particular object, etc. In another example, the context of a scene of a movie at a particular time instant may correspond to the semantic state of the movie as defined from one or more video frames of the movie that correspond to the time instant. The context may be identified based on metadata included with the video segment, a machine-learning model trained to determine (or predict) semantic meaning from one or more video frames, user input, and/or the like.

The instructions may be embedded into the video segment. For example, the instructions may be included in metadata of the video segment or video stream, data received with the video segment or in associated with the video segment, as a watermark (e.g., by modulating pixel values of video frames of the video segment, modify an audio channel of the video segment, etc.), combinations thereof, and/or the like. Alternatively, the instructions may be embedded into the interface of the computing device or other component of the computing device. The instructions may be synchronized with the video segment using a timestamp, time interval, token, etc. such that the instructions embedded into the interface or other component of the computing device may execute when a corresponding event is detected in the video segment (e.g., time instant of the video segment, token is detected, time interval lapses, etc.).

The instructions may be configured to request additional information associated with the context from one or more remote sources, request one or more acquisition protocols, define application programming interface calls, define remote procedure calls, modify the interface of the computing device (e.g., modify an appearance of the interface, modify a layout, retrieve or embed instructions such as JavaScript code, generate or remove windows or frames of the interface, combinations thereof, and/or the like), modify presentation of the video stream (e.g., by selecting one or more subsequent video segments to be presented after this video segment; by modifying a frame rate, resolution, refresh rate, contrast, brightness, language, combinations thereof, and/or the like based on processing capabilities of the computing device and/or current network conditions; combinations thereof; and/or the like), combinations thereof, and/or the like. For example, instructions may be embedded into the video segment that be executed upon presentation of the video segment. The instructions may retrieve a dynamic acquisition protocol and cause a portion of the interface of the computing device to present the dynamic acquisition protocol enabling the computing device and/or a user thereof to execute the dynamic acquisition protocol to acquire an instance of an object appearing in the video segment.

The computing device may execute a request for a dynamic acquisition protocol for an object associated with the context. The request may include an identification of the object, an identification of the context, an identification of the computing device (e.g., such as, but not limited to a device identifier of the computing device, an IP address of the computing device, a MAC address of the computing device, a geolocation of the computing device, hardware components installed in the computing device, software installed on the computing device, processing capabilities of the computing device, network status of the computing device, combinations thereof, an identification of the user (e.g., such as a username, user identifier, geolocation of the user, demographic information of the user, combinations thereof, and/or the like), information associated with the computing device and/or the user thereof (e.g., browsing history, historical object acquisitions, available resources, etc.), an identification of the video segment or video stream, combinations thereof, or the like. The request may be transmitted by executing the instructions. Alternatively, the request may be transmitted using the instructions to define the transmission or the request (e.g., such as information to include in the request, an address to transmit the request, etc.).

The request may be transmitted to a remote device configured to define dynamic acquisition protocols for particular computing devices and/or users. The device may be configured to facilitate acquisition of the object on behalf of the computing device and/or the user thereof by providing some or all of a set of resources requested in exchange for an instance of the object. The particular instructions and/or terms of the dynamic acquisition protocol may be defined by the remote device based on the particular computing device and/or the user thereof.

The computing device may receive the acquisition protocol from the remote device.

The computing device may then facilitate a presentation of the acquisition protocol in association with the presentation of the media segment. In some instances, the computing device may facilitate presentation of the acquisition protocol by modifying the interface to present the acquisition protocol next to the video segment. In other instances, the computing device may facilitate presentation of the acquisition protocol by generating a window or frame to present the acquisition protocol over the video segment, over a portion of the video segment, next to the video segment, or the like.

The computing device and/or the user thereof may execute the acquisition protocol to enable acquisition of an instance of the object. Execution of the acquisition protocol may cause the remote device to provide a set of resources to a provider of the instance of the object (e.g., identified by the request, etc.) causing the provider to transmit the instance of the object to the computing device and/or the user thereof.

The computing device may detect new instructions associated with a new current context of the video segment (or of a subsequent video segment). The computing device may terminate the presentation of the acquisition protocol. Alternatively, the computing device may wait until a new acquisition protocol is received (e.g., based on the new context) and replace a presentation of the acquisition protocol with a presentation of the new acquisition protocol. Alternatively, the new acquisition protocol may be presented in association with the video segment (or new video segment) while the acquisition protocol continues to be presented in another portion of the interface (e.g., such as under the new acquisition protocol, etc.).

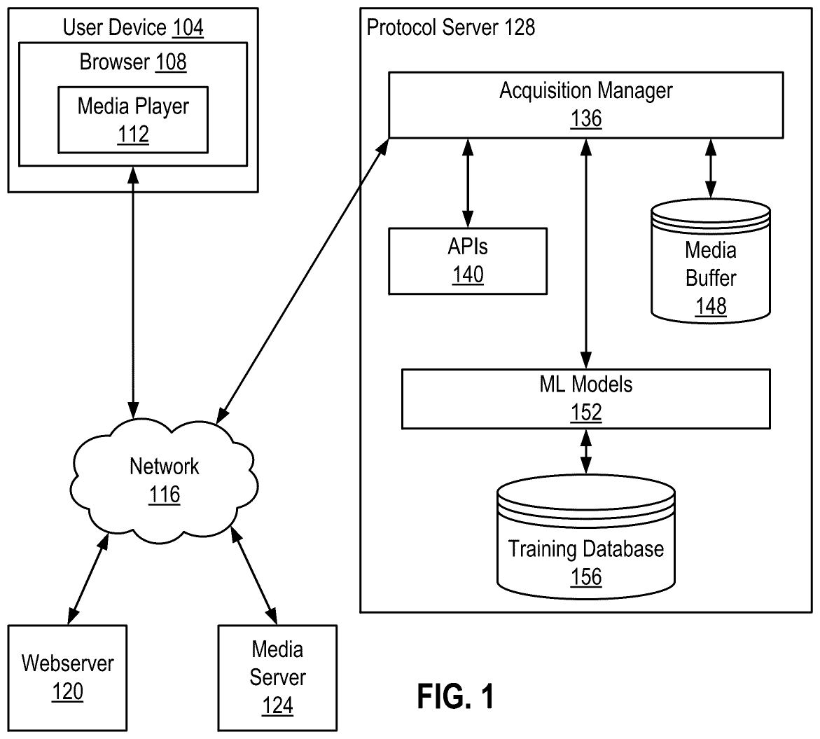

FIG. 1 illustrates a block diagram of example video-object acquisition system configured to synchronize a presentation of dynamic acquisition protocols with video segments according to aspects of the present disclosure. User device 104 may be a computing device (e.g., such as, but not limited to, a desktop or laptop computer, mobile device such as a smartphone or tablet, server, etc.) configured to access media hosted by one or more remote networks. User device 104 may present media using browser 108 (e.g., a web browser, etc.) operating media player 112. Alternatively, an application of user device may operate media player 112. Alternatively still, media player 112 may be an application of user device 104. User device 104 may present media streams (e.g., in which video and/or audio frames are presented shortly after being received and the video and/or audio frames are not retained by user device 104 once presented) or stored media (e.g., media stored within memory of user device 104 or accessible to user device 104).

Browser 108 may be configured to present additional information associated with the media adjacent to media player 112. The additional information may include, but is not limited to, an identification of objects appearing in the media, an identification of one or more users appearing in the media, metadata associated with the media (e.g., such as an identification of when the media stream was recorded if not live, a location in which the media was recorded, a setting of the media, characters appearing in the media, production personnel that produced the media, an identification of a webhost or managing entity, an identification of a media type and/or container, video and/or audio frame information, etc.), combinations thereof, and/or the like. Browser 108 may also present acquisition protocols associated with objects appearing in the media to enable a user of user device 104 to acquire the objects.

User device 104 may access resources of one or more remote devices through network 116 (e.g., local area network, wide area network, cloud network, the Internet, etc.). For example, user device 104 may request a webpage associated with a livestream or other streaming media from webserver 120. The requested webpage may be configured to present the livestream or other streaming media, present information associated with objects depicted in or referenced by the livestream or other streaming media, present instructions to access the objects, present acquisition protocols, combinations thereof, and/or the like. Webserver 120 may access the requested resources associated with the webpage. If the livestream or other streaming media is hosted by webserver 120, then webserver 120 may embed instructions to facilitate presentation of the livestream within the requested webpage by media player 112. If the livestream or other streaming media is not hosted by webserver 120, then webserver 120 may embed instructions that may access the embed instructions to facilitate presentation of the livestream within the requested webpage by media player 112 from another remote device such as media server 124, a database, another network, etc. Webserver 120 may also embed instructions that may request additional information associated with the livestream or other streaming media from protocol server 128.

When the webpage is loaded by browser 108, the instructions requesting additional information may execute. In some instances, the instructions may execute when the webpage is loaded. For example, the instructions requesting additional information may execute before the objects of the livestream or other streaming media are depicted or referenced to enable identifying the objects that will be depicted or referenced and/or to enable receiving information associated with the objects that will be depict or referenced before the objects are depicted or referenced. In other instances, the instructions may execute when a particular time of the livestream or other streaming media is reached (e.g., such as a time that coincides with a depiction or referencing of a particular object, etc.). The request for additional information may be received by acquisition manager 136 of protocol server 128. The request may include an identification of the webpage, an identification of the webhost, an identification of the livestream or other streaming media, an identification of an object currently being depicted or referenced by the livestream or other streaming media, an identification of a set of objects that will be depicted or referenced by the livestream or other streaming media, an identification of a source of any of the aforementioned objects, information associated with any of the aforementioned objects, an indication that the objects of the livestream or other streamlining media are unknown, combinations thereof, and/or the like.

Acquisition manager 136 may manage operations of protocol server 128 including scheduling, load balancing, training/execution of machine-learning models, communications with remote devices, etc. Acquisition manager 136 may parse the request from webserver 120 and generate a dynamic acquisition protocol (e.g., a set of instructions that can be executed by user device 104 and/or a user thereof to acquire an object associated with the dynamic acquisition protocol, etc.). A request for additional information may be received according to one or more events. A first event may be triggered when the webpage is loaded to request information associated with known objects that are expected to be depicted or referenced during the livestream or other streaming media. For example, an identification of the objects that are expected to be depicted or referenced during the livestream or other streaming media may be determined based on metadata within the livestream or other streamlining media, metadata or instructions embedded into the webpage, a watermark included in the livestream or other streaming media, a machine-learning model executing on user device 104, user input, information retrieved from webserver 120 or media server 124, combinations thereof, or the like. A second event may be triggered when the webpage is loaded to identify unknown objects that are expected to be depicted or referenced during the livestream or other streaming media and to request information associated with the unknown objects. A third event may be triggered when a particular object is depicted or referenced within the livestream or other streaming media.

If an identification of the object is known (e.g., included in the request for additional information), then acquisition manager 136 may use APIs 140 to identify information associated with the object (e.g., source of the object, value of the object, information associated with a user of user device 104, reviews of the object, etc.) from one or more devices such as user device 104 (e.g., including user information, etc.), protocol server 132 (e.g., information associated protocols configured to acquire etc.), a device associated with a source or provider of the object, etc. For instance, acquisition manager 136 may define one or more function calls or remote procedure calls of APIs 140 that retrieve the information associated with object. Alternatively, or additionally, the acquisition manager 136 may use APIs 140 to access a web crawler (or the like) configured to identify the information associated with the object. Alternatively, or additionally, acquisition manager 136 may retrieve the information associated with the object from local memory (or other accessible memory). For instance, webserver 120 and/or media server 124 may include metadata associated with the livestream or other streaming media. The metadata may include the information associated with each object depicted and/or referenced by the livestream or other streaming media.

Acquisition manager 136 may define an acquisition protocol based on the information associated with the object and an information associated with user device 104 and/or the user thereof. acquisition manager 136 may define an acquisition protocol by generating a sequence of instructions that may be executed by user device 104 and/or the user thereof. Alternatively, or additionally, acquisition manager 136 may define an acquisition protocol from template protocols. The acquisition protocols defined by acquisition manager 136 may be tailored to user device 104 and/or the user thereof. For instance, acquisition manager 136 may define an acquisition protocol that may be executed quickly (e.g., with some operations pre-executed based on information already known about the user, etc.), requiring fewer resources (e.g., lower rates, etc.).

Alternatively, or additionally, acquisition manager 136 may retrieve acquisition protocols from protocol server 128 and/or from local (or remote) memory. For instance, protocol server 128 may include a set of predefined acquisition protocols for one or more objects. Acquisition manager 136 may select a particular predefined acquisition protocol from the set of predefined acquisition protocols for user device 104 and/or the user thereof. In some instances, acquisition manager 136 may select a particular predefined acquisition protocol based on information associated with user device 104 and/or the user thereof to provide an acquisition protocol that may be likely to be executed by user device 104 and/or the user thereof.

For example, the object may be promoted by a livestream. When the object is being depicted or referenced, the instructions within the webpage may execute to request a dynamic acquisition protocol from protocol server 128. Protocol server 128 may use an identification of the object, an identification of user device 104 and/or the user thereof, etc. to define a dynamic acquisition protocol for user device 104 and/or the user thereof that when executed by user device 104 and/or the user thereof will cause a source or provider of the object to transmit an instance of the object to user device 104 and/or the user thereof.

In some instances, an identification of the objects depicted within the livestream or other streaming media may be unknown. In those instances, user device 104 may identify the objects using a machine-learning model, user input, and/or the like. Alternatively, user device 104 may transmit a request to protocol server 128 to identify the objects within the livestream or other streaming media. Protocol server 128 may process live media (e.g., livestreams, etc.) in parallel with the presentation of the live media by user device 104. Protocol server 128 may process non-live media in advance (e.g., initiating when the request to identify objects is received, at some time after receiving the request to identify the objects, in a batch process, and/or the like. Protocol server 128 may access the livestream or other streaming media in parallel with user device 104. Protocol server 128 may use a machine-learning model, object detection algorithm, metadata, and/or the like to detect and identify the objects depicted in or referenced by the livestream or other streaming media.

For example, acquisition manager 136 may use ML models 152 to detect and identify object depicted in or referenced by the livestream or other streaming media. ML models 152 may include one or more machine-learning models trained to detect objects within visual or auditory media. Examples of machine-learning models include, but are not limited to, deep learning networks, neural networks, convolutional neural networks (e.g., and/or variants thereof such as, but not limited to, region-based convolution neural networks (R-CNN), faster convolution neural networks (F-CNN), faster region-based convolutional neural networks FR-CNN, and/or the like), You Only Look Once (YOLO), EfficientDet, recurrent neural networks (and/or variants thereof such as Long, Short Term Memory (LSTM), mask recurrent neural networks, etc.), transformers (such as generative pre-trained transformers (GPT), Bidirectional Encoder Representations from Transformers (BERTs), text-to-text-transfer-transformer (T5), etc.), generative adversarial networks (GANs), recurrent gated units (GRUs), combinations thereof, or the like. Acquisition manager 136 may train different types of machine-learning models to process different types of media or different portions of media. For instance, acquisition manager 136 may train a region-based convolutional neural network to detect and identify objects within an image or frame of video and a long-short term memory machine-learning model to process an audio channel of the video.

The machine-learning model may be trained using training data retrieved from training database 156. Training database 156 may store media of a same or similar type as the livestreams or other streaming video, metadata associated with the media, labels, features derived from the media, manually and/or procedurally generated media and/or features, feature vectors used as input to machine-learning models and/or used during training or post-training operations, etc. Acquisition manager 136 may define a training dataset for each machine-learning model being trained based on a model type of the machine-learning model being trained, a training algorithm used to train the machine-learning model (e.g., such as supervised training, unsupervised training, etc.), an expected input of the machine-learning model (e.g., input type such as an image, audio segment, video, vector, etc.; input content such as particular features, etc.; combinations thereof, and/or the like), an expected output of the machine-learning model (e.g., boundary boxes, classifications, probabilities, confidence values, etc.), combinations thereof, and/or the like.

The training dataset may include representations of particular objects to be identified (e.g., such as a particular make, model, and year of a car), representations of classes of objects in which a particular object to be identified is a member (e.g., such as cars, etc.), and/or the like. If the training dataset includes limited representations of particular objects, classes of objects, etc. (e.g., too few to train the machine-learning model), the training dataset may be augmented with additional data associated with the particular objects. The additional data may include manually generated data associated with the particular objects or classes of objects, data associated with similar objects, procedurally generated data associated with the particular objects or classes of objects, combinations thereof, and/or the like. In some instances, such as when the machine-learning model is to be training using supervised learning techniques, labels may be added to the training dataset. The labels may be generated manually (e.g., via user input, etc.), by an already trained instance of the machine-learning model, by a generative adversarial network or other machine-learning model, combinations thereof, and/or the like.

The machine-learning model may be trained using supervised learning, unsupervised learning, semi-supervised learning, transfer learning, metalearning, reinforcement learning, combinations thereof, or the like using a training dataset derived from video streams and/or images of objects to be identified within video streams. The machine-learning model may be trained over a predetermined time interval, for predetermined quantity of iterations, and/or until one or more accuracy metrics are reached (e.g., such as, but not limited to, accuracy, precision, area under the curve, logarithmic loss, F1 score, a longest common subsequence (LCS) such as ROUGE-L, Bilingual evaluation Understudy (BLEU) mean absolute error, mean square error, or the like.

Acquisition manager 136 may use media buffer 148 to store audio frames and/or video frames from the livestream or other streaming media. Acquisition manager 136 may use the stored audio frames and/or video frames to generate inputs for the machine-learning model. In some instances, the inputs may be features vectors. For example, acquisition manager may extract features from an audio frame and/or video frame (e.g., using imaging and/or audio processing operations such as, but not limited to, pixel values and/or normalized pixel values, edge detection, principal component analysis, filtering, wavelets, partial differential equations, etc.) and organize the extracted features according to a structured hierarchy or dimension (e.g., such as time or space, etc.). One or more feature vectors may be passed to as input to the machine-learning model to generate one or more outputs. In some instances, the inputs may include the audio frame and/or the video frame, modified representations of the audio frame and/or video frame (e.g., such as audio frames and/or video frames processed via one or more image and/or audio processing operations, etc.). Media buffer 148 may be a first-in-first-out (FIFO) buffer in which acquisition manager 136 may process the oldest audio frame, video frame, or pair of audio frame and video frame stored in media buffer 148. In some instances, acquisition manager 136 may store audio frames and/or video frames of media buffer 148 along with the processed portions thereof used as input to the machine-learning model in training database 156 for use in training the machine-learning model and/or subsequent machine-learning models.

The machine-learning model may output an identification of an object within the livestream or other streaming media along with a timestamp corresponding to the location within the livestream or other streaming media in which the object is depicted or referenced. Acquisition manager 135 may retrieve information associated with the identified object and define an acquisition protocol based on the identified object and information associated with user device 104 and/or the user thereof. The acquisition protocol may be transmitted to user device 104 to enable the presentation of the acquisition protocol while the identified object is still be depicted and/or referenced within the livestream or other streaming media.

Acquisition manager 135 may transmit the defined acquisition protocols to the webpage via browser 108 of user device 104. The acquisition protocol may include instructions to facilitate the presentation and execution of the acquisition protocol. When embedded into a webpage, the instructions may include hypertext markup language (HTML), JavaScript, etc. In some instances, the acquisition protocols may be presented without impacting the presentation of the livestream or other streaming media (e.g., without causing the webpage to be reloaded, etc.). The acquisition protocol may be presented in association with the object being depicted or referenced within the livestream. If the object is known and associated with a timestamp (e.g., the acquisition protocol is requested based on known object associated with a known time in which the object will be depicted and/or referenced), then the acquisition protocol may be presented when the current presentation time of the livestream or other streaming service corresponds to the timestamp. If the object is known and not associated with a timestamp (e.g., the acquisition protocol is requested when the object is depicted and/or referenced), then the acquisition protocol may be presented upon being received by the webpage. In cases where the objects are initially unknown, protocol server 128 may process the livestream or other streaming media in real time (e.g., as approximately a same time as user device 104). Protocol server 128 may identify objects, define acquisition protocols, and transmit the acquisition protocols to user device 104 in real time causing the acquisition protocols to be received by user device 104 shortly after (e.g., milliseconds, seconds, etc. subject to the processing time of protocol server 128 and latency of network 116 or connections thereof) the object of the acquisition protocol is depicted or referenced within the livestream or other streaming service. The processing latency may be reduced by increasing instances of protocol server 128, increasing parallel processing, adding additional processing cores (e.g., central processing unit and/or graphics processing units, etc.), load balancing, combinations thereof, and/or the like.

Acquisition protocols may be presented within the webpage until the acquisition protocol is replaced by a new acquisition protocol is received by the webpage. Alternatively, the acquisition protocols may be presented sequentially with the most recently received acquisition protocol presented on top (in a descending order) or first. Alternatively, acquisition protocols may be presented while the object associated with the acquisition protocol is being depicted or referenced within the livestream or other streaming media (e.g., as determined by protocol server 128, etc.). For instance, protocol server 128 may identify an object and transmit a defined acquisition protocol to a webpage presented by browser 108. When protocol server 128 determines the object is no longer being depicted or referred to, protocol server 128 may transmit a communication to the webpage presented by browser 108 causing the webpage to stop presenting the acquisition protocol.

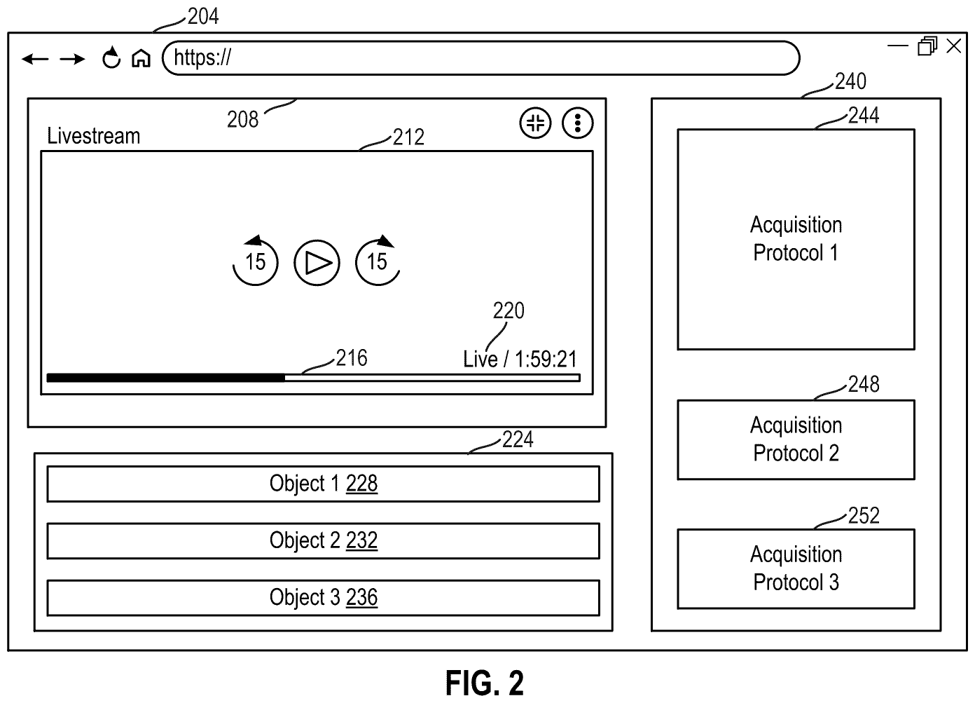

FIG. 2 illustrate an example interface configured to present video segments and dynamic acquisition protocols according to aspects of the present disclosure. Interface 204 may be graphical user interface configured to represent media and/or other information to users. In some instances, interface 204 may be a dynamic interface including an appearance and functionality determined at runtime (e.g., when interface 204 is loaded) and/or determined based on processing capabilities of a device that loads interface 204. For example, interface 204 may include instructions that may detect capabilities of the device and selectively execute particular instructions based on the capabilities to enable particular functionality usable by the device and/or project an appearance of interface 204 that appears native to the device. Interface 204 may project a consistent appearance of interface 204 based on display capabilities of the device modifying a size, resolution, font, orientation, color scheme, etc. of media or other content to be presented through interface 204; modifying a location of the media, a location of other content or frames, etc.; modifying a presentation order of media, other content, frames, etc. to be presented via interface 204; combinations thereof, and/or the like. For instance, interface 204 may resize a portion of interface 204 presenting media based on the capabilities of a display of the device (e.g., resolution, zoom state, etc.) to preserve an appearance of the portion of the interface. Interface 204 can be represented as a webpage within a browser (e.g., as shown), as a portion of a native application, or the like.

Interface 204 may include object 208 configured to present media such as, but not limited to, stored media, downloaded media, streaming media, live media (e.g., such as a livestream, etc.), combinations thereof, and/or the like. The media may include images, video, audio, combinations thereof, and/or the like. Object 208 may include an identification of the media (e.g., such as a serial number, object identifier, title, etc.), controls to modify a presentation of the media (e.g., such as a presentation in full screen, a presentation in another interface such as an interface to be presented over interface 204, frame rate controls, resolution controls, color correction controls such as for color blindness or other visual impairments, combinations thereof, and/or the like). Object 208 may present the media within window 212. Window 212 may be configured to present additional information and/or controls when a particular event is detected such as cursor-over events (e.g., occurring when a cursor is moved over window 212 or object 208, etc.), timed events (e.g., occurring at regular intervals of the presentation of the media, etc.), instruction-triggered events (e.g., occurring upon receiving or detecting instructions embedded within the media, etc.), combinations thereof, and/or the like. Upon detecting the particular event, window 212 may present progress bar 216 (e.g., indicating a current instant of the media that is being presented relative to an expected length of the media, etc.), timer 220 (e.g., providing an indication of a media type such as live media or non-live media as well as a numerical indication of a length of the presentation, etc.), etc. Window 212 may include one or more additional controls enabling the current instant of the media that is currently being presented to moved backwards (e.g., rewind, etc.), forwards (e.g., fast-forward, etc.) within the presentation of the media, paused, played, etc.

Interface 204 may include element 224 including a representation of objects depicted in the media presented in object 208. In some instances, interface 204 may include instructions that may execute to identify objects depicted in the media. For instance, interface 204 may include a machine-learning model (e.g., such as a convolutional neural network, and/or any of the aforementioned machine-learning models) configured to detect objects within graphical media. Alternatively, or additionally, interface 204 may include a machine-learning model configured to detect objects from audio segments. In other instances, interface 204 may receive an identification of objects depicted in the media when the object is depicted within the media. An identification of the objects may be embedded into the media as metadata, executable instructions, watermarks, etc. Interface 204 may receive or detect the identification of the object being depicted at approximately the same time as the object is depicted in the media. In other instances, interface 204 may receive the identification of the objects depicted in the media when the media is loaded by the interface 204. The information associated with each object may be associated with a timestamp corresponding to the instant within the media in which the object will be depicted.

Interface 204 may execute a query (e.g., to a local or remote database, etc.) using the identification of an object. The query may return information associated with the object that may be presented in a portion of element 224 (e.g., as Object A 228, Object B 232, Object C 236, etc.). The information associated with the object may include, but is not limited to, an identification of the object (e.g., name, serial number, model number, etc.), characteristics of the object (e.g., an object type, dimensions of the object, color of objection, functionality of the object, etc.), information associated with one or more manufacturers of the object, an identification of a way of acquiring an instance of the object (e.g., a store, website, etc.), reviews of the object, an identification of a popularity of the object, one or more links to external information sources associated with the object, combinations thereof, and/or the like.

In some instances, element 224 may present information associated with the object that is currently being depicted by the media. Element 224 may present information associated with the object indefinitely, for a particular time interval, until a new object is depicted within the media, and/or the like. In other instances, element 224 may present information associated with each object that has been depicted by the media so far (e.g., from a start time of the presentation of the media to the current time). Element 224 may present the objects in the order in which the objects were depicted in the media. For example, element 224 may present the objects in descending order (e.g., with the most recently depicted object presented on top as Object A 228) or ascending order (e.g., with the first object to be depicted in the media presented on top as Object A 228). In other instances, element 224 may present information associated with each object that has been depicted or will be depicted within the media. Element 224 may present the objects in the order in which the objects were depicted in the media. For example, element 224 may present the objects in descending order or ascending order.

Interface 204 may include acquisition frame 240 configured to present one or more acquisition protocols that, upon selection, may execute to facilitate acquisition of the object depicted in the media. Interface 204 synchronize the presentation of acquisition protocols with the presentation of the media. For instance, interface 204 may be configured to present the acquisition protocol when the corresponding object is depicted within the media. In some instances, the media may include instructions (e.g., such as a JavaScript, etc.) that may be received by interface 204. The instructions may be received by interface 204 prior to the object being depicted with the media or at approximately at the same time as when the object is depicted within the media. In some examples acquisition frame 240 may be linked to element 224 and present acquisition protocols that correspond with objects identified by element 224. The instructions may execute to request an acquisition protocol from a remote device (e.g., such as a device affiliated with a source of the media or a device that is unaffiliated with the source of the media, etc.). Interface 204 may receive a response from the remote device that includes a set of instructions corresponding to an acquisition protocol.

In some instances, acquisition frame 240 may present acquisition protocols associated with the object that is currently being depicted within the media. Acquisition frame 240 may present the acquisition protocol associated with the object indefinitely, for a particular time interval, until a new object is depicted within the media, and/or the like. In other instances, acquisition frame 240 may present an acquisition protocol associated with each object that has been depicted by the media so far (e.g., from a start time of the presentation of the media to the current time). Acquisition frame 240 may present the acquisition protocols in the order in which the objects were depicted in the media. For example, acquisition frame 240 may present the acquisition protocols in descending order (e.g., with the most recently depicted object presented on top as acquisition protocol A 244, followed by acquisition protocol B 248 corresponding to an object depicted before the object associated with acquisition protocol A 244, etc.) or ascending order (e.g., with the first object to be depicted in the media presented on top as acquisition protocol A 244 and acquisition protocol 252 representing the object that was most recently depicted, etc.). In other instances, acquisition frame 240 may present acquisition protocols associated with each object that has been depicted or will be depicted within the media (e.g., the acquisition protocols may be presented when the media is loaded). Acquisition frame 240 may present the acquisition protocols in the order in which the objects were depicted in the media. For example, acquisition frame 240 may present the acquisition protocols in descending order or ascending order.

Interface 204 illustrates an example orientation of the presentation of the media and acquisition protocols associated objects depicted in the media. Interface 204 may be presented in any orientation in which the media and acquisition protocols can be presented on a same display device (e.g., within a same interface, multiple interfaces, etc.).

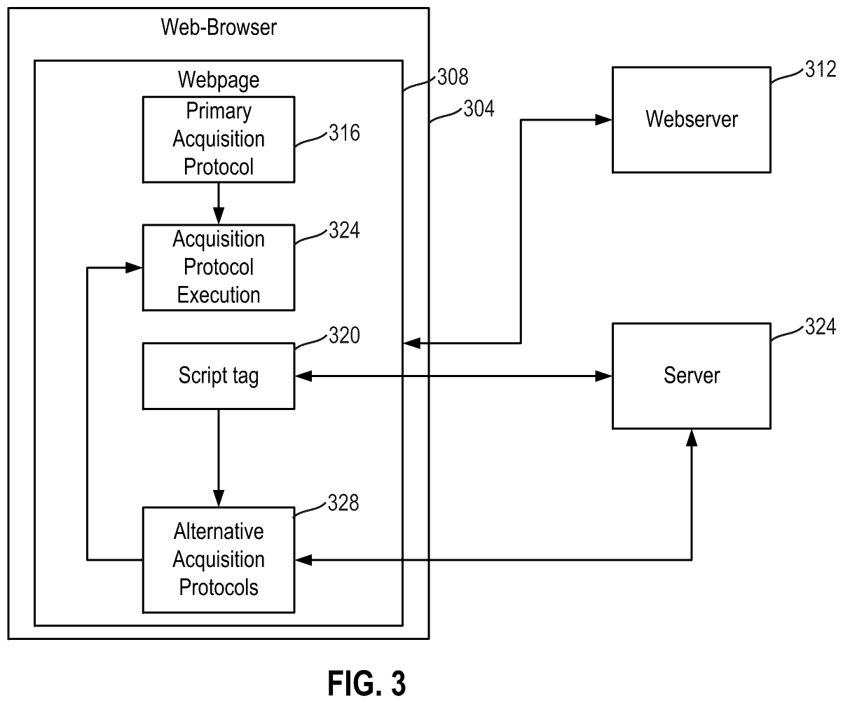

FIG. 3 illustrates an example block diagram depicting customizing an interface to display alternative acquisition protocols according to aspects of the present disclosure. Application may be a software application executing on a computing device (e.g., mobile device such as a smartphone, desktop or laptop computer, server, etc.). Application 304 may receive instructions to generate interface 308. Application 304 may transmit a request to a webserver and receive instructions that enable application 304 to generate interface 308. Interface 308 may be configured to present media (e.g., such as, but not limited to stored media, streaming media such as live or non-live media, and/or the like) along with access to objects depicted within the media.

Application 304 may execute instructions within interface 308 to render graphical portions of interface 308 such a graphical user interface, the media, acquisition protocols, etc. Interface 308 may include instructions that may execute when particular objects are depicted within the media. Alternatively, or additionally, interface 308 and/or application 304 may include instructions that may detect objects depicted within interface 308 and/or media of interface 308. Alternatively, or additionally, interface 308 may be receive an identification of objects that will be presented within the media. For example, script tag 320 may be embedded into interface 308 and/or the media. Script tag 320 may include a script (e.g., a set of instructions) that may execute to retrieve and display an acquisition protocol for a corresponding object being depicted by the media. When presentation of the media reaches a particular time instant (e.g., timestamp within the media) that corresponds to expected depiction of an object, script tag 320 may execute to retrieve the acquisition protocol that corresponds to the object being depicted. Script tag 320 may be received when interface 308 is generated, when any time before the object is depicted within the media, approximately simultaneously with the presentation of the object, retrieved upon detecting the object (e.g., based on a machine-learning model detecting the object, detecting an identification of the object in an audio or text channel of the media, and/or the like.

Executing the script of script tag 320 may cause interface 308 to transmit a communication to server 324 requesting one or more acquisition protocols for the object. The communication may include an identification of the object, an identification of a source of the object (e.g., webpage or other interface, server, company or other entity, etc.), an identification of the computing device (e.g., serial number, unique identifier, Internet Protocol address, Media Access Control address, etc.), characteristics of the computing device (e.g., hardware components installed, software installed, etc.), network characteristics (e.g., Internet Service Provider, bandwidth, IP address, MAC address, etc.), an identification of interface 308, an identification of the media, an identification of the user of the computing device, characteristics of the user of the computing device (e.g., demographic information, user name, user identifier, historical acquisition protocols request and/or executed, historical media accessed via interface 308, combinations thereof, and/or the like), combinations thereof, and/or the like. Server 324 may use the information included in the communication to identify one or more acquisition protocols usable by the computing device to acquire the object depicted within the media. For example, server 324 may identify an acquisition protocol based on a geolocation of the computing device and historical acquisition protocol executed by the computing device and/or the user thereof. Server 324 may select the one or more acquisition protocols and transmit the one or more acquisition protocols to interface 308. Alternatively, or additionally, server 324 may generate one or more of the one or more acquisition protocols or request one or more of the one or more acquisition protocols from another remote device.

In some instances, server 324 may generate a score to each potential acquisition protocols based on the communication, information known about the computing device and/or the user, combinations thereof, and/or the like. For example, a score may be assigned based on a likelihood that the user and/or computing device will select an acquisition protocol, a likelihood that the computing device and/or the user will execute the acquisition protocol, a degree in which the alternative acquisition protocol is matches the user and/or computing device (e.g., based on the information included in the communication, information known about the computing device and/or user, combinations thereof, and/or the like). Server 324 may select one or more acquisition protocols based on the score. For instance, server 324 may select the one or more acquisition protocols with a highest score, the acquisition protocols that have a score greater than a threshold score, or the like.

Alternatively, server 324 may generate scores for acquisition protocols using a machine-learning model. The machine-learning model may be trained using historical data associated with acquisition protocols such as, but not limited to, previous instances in which acquisition protocols where transmitted to computing devices and/or users, an identification of acquisition protocols executed by computing devices and/or users, information associated with the computing devices and/or users, an identification of objects acquired by executed acquisition protocols, combinations thereof, and/or the like. Server 324 may generate a feature vector using the information included in the communication from the computing device and execute the machine-learning model using the feature vector to derive a prediction (e.g., a prediction of the likelihood that the acquisition protocols will be selected by the user, etc.) for each acquisition protocol for the computing device and/or the user. The prediction may be the score assigned to the acquisition protocol or the prediction may be processed to derive the score for the acquisition protocols. The machine-learning model may be a classifier such as, but not limited to, a support vector machine, logistic regression, nearest neighbor, k-means, decision tree, Naïve Bayes, or any other classifier).

Server 324 may transmit the selected one or more acquisition protocols to acquisition protocols 328 of interface 308. Script tag 320 may determine which acquisition protocol to be presented through interface 308. If more than one acquisition protocol is received, script tag 320 may present first present the acquisition protocol with the highest score and present other acquisition protocols upon receiving an indication that the user declined the acquisition protocol. Alternatively, script tag 320 may present one or more of the acquisition protocols that are received.

Acquisition protocol execution 316 includes instructions that execute a selected acquisition protocol. Executing an acquisition protocol may cause a portion of the interface to present additional interface to facilitate acquisition of the object associated with the acquisition protocol. For instance, the acquisition protocol may be presented with a frame of a webpage. Upon execution of the acquisition protocol, the frame of the webpage may be redirected to a new uniform resource locator (URL) address causing the frame to load a new webpage within the frame of the webpage. The new webpage may facilitate acquisition of the object. Alternatively, the new webpage may be loaded within a separate window or the like. The additional interface may request additional information from the user (e.g., such as but not limited to, location information, resource information associated with the user, etc.). The additional interface may then transfer resources to a source of the object associated with the acquisition protocol and facilitate a transfer of an instance of the object from the source of the object to the computing device and/or the user. For example, the acquisition protocol may be associated with a resource (e.g., credit, etc.) provider identified by server 324 as likely to provide the resources requested by the source of the object on behalf of the computing device or user. The user may execute the acquisition protocol to load an interface of the resource provider of the acquisition protocol to complete the acquisition protocol. The resource provider may then provide the resources for an instance of the object on behalf of the user.

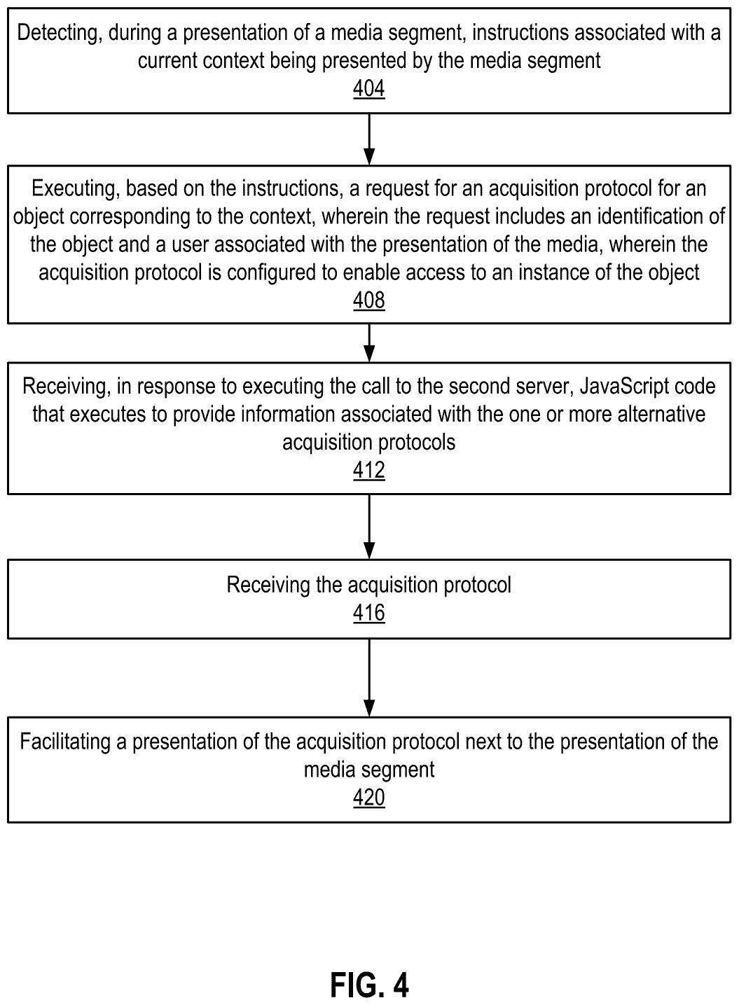

FIG. 4 illustrates a flowchart of an example process for detecting boundaries relative to linear programming according to aspects of the present disclosure. A computing device may connect to a media stream. The media stream may include audiovisual segments (e.g., movie, television show, video segment, livestream, etc.) or audio segments (e.g., radio, podcast, etc.). The computing device may connect to the media stream through a web-based interface (e.g., browser, etc.), an application associated with the media stream, a native application (e.g., an application of the computing device configured to present media), and/or the like. The computing device may then present a media segment of the media stream (e.g., one or more media frames of the media stream) in an interface configured to simultaneously present additional information associated with the media segment or media stream. The computing device may begin presenting the media segment as the media stream is received, after a predetermined portion of the media stream is received by the computing device, or after the entire media stream is received by the computing device.

At block 404, the computing device may detect instructions associated with a current context of the media segment. A context may be a representation of a semantic state of the media segment at a given time instant. For example, in a livestream promoting one or more objects, the context at a particular time instant may correspond to the promotion of a particular object of the one or more objects. In another example, the context of a scene of a movie at a particular time instant, which may correspond to a semantic classification of scene. The context may be identified based on metadata included with the media segment, instructions included with the media segment, a machine-learning model trained to detect (or predict) the context, and/or the like.

In some instances, instructions may be embedded into the media segment. For example, the instructions may be included in metadata of the media segment or video stream, data received with the media segment or in association with the media segment, in a watermark (e.g., by modulating pixel values of video frames of the media segment, modify an audio channel of the media segment, etc.), combinations thereof, and/or the like. Alternatively, the instructions may be embedded into the interface of the computing device or other component of the computing device. The instructions may be synchronized with the media segment using a timestamp, time interval, token, etc. For example, the instructions may be configured to execute when at a particular time or upon detection of an event (e.g., such as, but not limited to, the expiration of a time interval, detecting a token, detecting a particular object depicted in the media segment, detecting audible words in the media segment, combinations thereof, and/or the like).

The instructions may be configured to request additional information associated with the context from one or more remote sources, request one or more acquisition protocols, define application programming interface calls, define remote procedure calls, modify the interface of the computing device (e.g., modify an appearance of the interface, modify a layout, retrieve or embed instructions such as JavaScript code, generate or remove windows or frames of the interface, combinations thereof, and/or the like), modify a presentation of the media stream (e.g., by selecting one or more subsequent media segments to be presented after this media segment; by modifying a frame rate, a resolution, a refresh rate, a contrast, a brightness, a language, combinations thereof, and/or the like; combinations thereof; and/or the like), combinations thereof, and/or the like. For example, instructions may be embedded into the media segment that be executed when an object is being promoted within the media segment. The instructions may retrieve a dynamic acquisition protocol and cause a portion of the interface of the computing device to present the dynamic acquisition protocol enabling the computing device and/or a user thereof to execute the dynamic acquisition protocol to acquire an instance of the object appearing in the media segment.

At block 408, the computing device may execute a request for a dynamic acquisition protocol for an object associated with the context. The request may include an identification of the object, an identification of the context, an identification of the computing device (e.g., such as, but not limited to a device identifier of the computing device, an IP address of the computing device, a MAC address of the computing device, a geolocation of the computing device, hardware components installed in the computing device, software installed on the computing device, processing capabilities of the computing device, network status of the computing device, combinations thereof, and/or the like), an identification of the user (e.g., such as a username, user identifier, geolocation of the user, demographic information of the user, combinations thereof, and/or the like), information associated with the computing device and/or the user thereof (e.g., browsing history, historical object acquisitions, available resources, etc.), an identification of the media segment or video stream, combinations thereof, or the like. The request may be transmitted by executing the instructions. Alternatively, the request may be transmitted using the instructions to define the transmission or the request (e.g., such as information to include in the request, an address to transmit the request, etc.).

The request may be transmitted to a remote device configured to define dynamic acquisition protocols for particular computing devices and/or users. The device may be configured to facilitate acquisition of the object on behalf of the computing device and/or the user thereof by providing some or all of a set of resources requested in exchange for an instance of the object. The particular instructions and/or terms of the dynamic acquisition protocol may be defined by the remote device based on the particular computing device and/or the user thereof. The remote device may be the same device providing the media segment or another remote device.

In some instances, the computing device may receive instructions from the remote device, the instructions may be configured to execute to retrieve information associated with the one or more alternative acquisition protocols. The instructions may be executed by the interface such as, but not limited to, JavaScript, WebAssembly, C, C++, bytecode, etc. Alternatively, the instructions may be configured to execute to present the one or more acquisition protocols.

At block 412, the computing device may receive the one or more alternative acquisition protocols in response to executing the received instructions.

At block 416, the computing device may then facilitate a presentation of at least one of the one or more acquisition protocols in association with the presentation of the media segment. In some instances, the computing device may facilitate presentation of the acquisition protocol by modifying the interface to present the acquisition protocol next to the media segment. In other instances, the computing device may facilitate presentation of the acquisition protocol by generating a window or frame to present the acquisition protocol over the media segment, over a portion of the media segment, next to the media segment, or the like.

The computing device and/or the user thereof may execute the acquisition protocol to enable acquisition of an instance of the object. Execution of the acquisition protocol may cause the remote device to provide a set of resources to a provider of the instance of the object (e.g., identified by the request, etc.) causing the provider to transmit the instance of the object to the computing device and/or the user thereof.

The computing device may detect new instructions associated with a new current context of the media segment (or of a subsequent media segment). The computing device may terminate the presentation of the acquisition protocol. Alternatively, the computing device may wait until a new acquisition protocol is received (e.g., based on the new context) and replace a presentation of the acquisition protocol with a presentation of the new acquisition protocol. Alternatively, the new acquisition protocol may be presented in association with the media segment (or new media segment) while the acquisition protocol continues to be presented in another portion of the interface (e.g., such as under the new acquisition protocol, etc.).

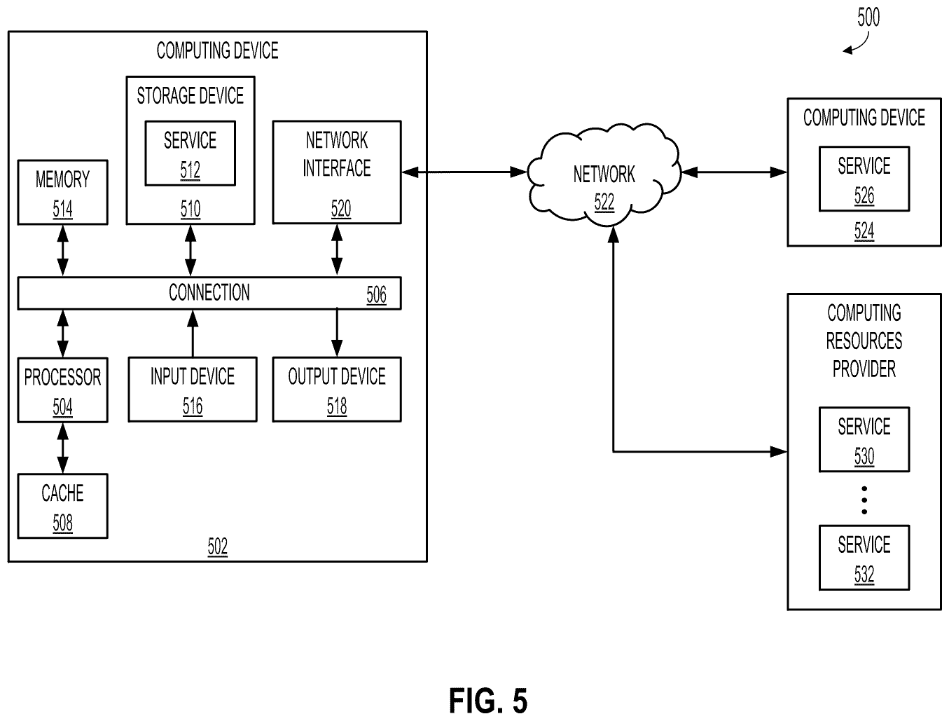

FIG. 5 illustrates a computing system architecture including various components in electrical communication with each other according to aspects of the present disclosure. The example computing system architecture 500 illustrated in FIG. 5 includes a computing device 502, which has various components in electrical communication with each other using a connection 506, such as a bus, in accordance with some implementations. The example computing system architecture 500 includes a processor 504 that is in electrical communication with various system components, using the connection 506, and including the system memory 514. In some embodiments, the system memory 514 includes read-only memory (ROM), random-access memory (RAM), and other such memory technologies including, but not limited to, those described herein. In some embodiments, the example computing system architecture 500 includes a cache 508 of high-speed memory connected directly with, in close proximity to, or integrated as part of the processor 504. The computing system architecture 500 can copy data from the system memory 514 and/or the storage device 510 to the cache 508 for quick access by the processor 504. In this way, the cache 508 can provide a performance boost that decreases or eliminates processor delays in the processor 504 due to waiting for data. Using modules, methods and services such as those described herein, the processor 504 can be configured to perform various actions. In some embodiments, the cache 508 may include multiple types of cache including, for example, level one (L1) and level two (L2) cache. The system memory 514 may be referred to herein as system memory or computer system memory. The system memory 514 may include, at various times, elements of an operating system, one or more applications, data associated with the operating system or the one or more applications, or other such data associated with the computing device 502.

Other system memory 514 can be available for use as well. The system memory 514 can include multiple different types of memory with different performance characteristics. The processor 504 can include any general-purpose processor and one or more hardware or software services, such as service 512 stored in storage device 510, configured to control the processor 504 as well as a special-purpose processor where software instructions are incorporated into the actual processor design. The processor 504 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 504 can be a microprocessor, a microcontroller, a digital signal processor (“DSP”), or a combination of these and/or other types of processors. In some embodiments, the processor 504 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 500, an input device 516 can represent any number of input mechanisms, such as a microphone for speech, a touch-sensitive screen for gesture or graphical input, keyboard, mouse, motion input, pen, and other such input devices. An output device 518 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 500. In some embodiments, the input device 516 and/or the output device 518 can be coupled to the computing device 502 using a remote connection device such as, for example, a communication interface such as the network interface 520 described herein. In such embodiments, the communication interface can govern and manage the input and output received from the attached input device 516 and/or output device 518. As may be contemplated, there is no restriction on operating on any particular hardware arrangement and accordingly the basic features here may easily be substituted for other hardware, software, or firmware arrangements as they are developed.

In some embodiments, the storage device 510 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 510 can include hardware and/or software services such as service 512 that can control or configure the processor 504 to perform one or more functions including, but not limited to, the methods, processes, functions, systems, and services described herein in various embodiments. In some embodiments, the hardware or software services can be implemented as modules. As illustrated in example computing system architecture 500, the storage device 510 can be connected to other parts of the computing device 502 using the connection 506. In some embodiments, a hardware service or hardware module such as service 512, that performs a function can include a software component stored in a non-transitory computer-readable medium that, in connection with the necessary hardware components, such as the processor 504, connection 506, cache 508, storage device 510, system memory 514, input device 516, output device 518, and so forth, can carry out the functions such as those described herein.

The disclosed systems and services can be performed using a computing system such as the example computing system illustrated in FIG. 5, using one or more components of the example computing system architecture 500. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some examples, the processor can be configured to carry out some or all of methods and systems described in connection with the authentication systems described herein by, for example, executing code using a processor such as processor 504 wherein the code is stored in memory such as system memory 514 as described herein. One or more of a user device, a provider server or system, a database system, or other such devices, services, or systems may include some or all of the components of the computing system such as the example computing system illustrated in FIG. 5, using one or more components of the example computing system architecture 500 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital representative (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 528. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 504 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The system memory 514 can be coupled to the processor 504 by, for example, a connector such as connection 506, or a bus. As used herein, a connector or bus such as connection 506 is a communications system that transfers data between components within the computing device 502 and may, in some embodiments, be used to transfer data between computing devices. The connection 506 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The system memory 514 can include RAM including, but not limited to, dynamic RAM (DRAM), static RAM (SRAM), synchronous dynamic RAM (SDRAM), non-volatile random-access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The system memory 514 can also include magnetic or optical data storage media including read-only (e.g., CD ROM and DVD ROM) or otherwise (e.g., CD or DVD). The memory can be local, remote, or distributed.

As described above, the connection 506 (or bus) can also couple the processor 504 to the storage device 510, which may include non-volatile memory or storage, a drive unit, and/or the like. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 510. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 506 can also couple the processor 504 to a network interface device such as the network interface 520. The interface can include one or more of a modem or other such network interfaces including, but not limited to those described herein. It will be appreciated that the network interface 520 may be considered to be part of the computing device 502 or may be separate from the computing device 502. The network interface 520 can include one or more of an analog modem, Integrated Services Digital Network (ISDN) modem, cable modem, token ring interface, satellite transmission interface, or other interfaces for coupling a computer system to other computer systems. In some embodiments, the network interface 520 can include one or more input and/or output (I/O) devices. The I/O devices can include, by way of example but not limitation, input devices such as input device 516 and/or output devices such as output device 518. For example, the network interface 520 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 502 can be connected to one or more additional computing devices such as computing device 524 via a network 522 using a connection such as the network interface 520. In such embodiments, the computing device 524 may execute one or more services (e.g., service 526, etc.) to perform one or more functions under the control of, or on behalf of, programs and/or services operating on computing device 502. In some embodiments, a computing device such as computing device 524 may include one or more of the types of components as described in connection with computing device 502 including, but not limited to, a processor such as processor 504, a connection such as connection 506, a cache such as cache 508, a storage device such as storage device 510, memory such as system memory 514, an input device such as input device 516, and an output device such as output device 518. In such embodiments, the computing device 524 can carry out the functions such as those described herein in connection with computing device 502. In some embodiments, the computing device 502 can be connected to a plurality of computing devices such as computing device 524, each of which may also be connected to a plurality of computing devices such as computing device 524. Such an embodiment may be referred to herein as a distributed computing environment.

The network 522 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 522 can be wired connections, wireless connections, or combinations thereof. Communications via the network 522 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 522, within the computing device 502, within the computing device 524, or within the computing resources provider 528 can include information, which also may be referred to herein as content. The information may include text, graphics, audio, video, haptics, and/or any other information that can be provided to a user of the computing device such as the computing device 502. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 502 and presented to a user of the computing device 502 using forms that are perceptible via sight, sound, smell, taste, touch, or other such mechanisms. In some embodiments, communications over the network 522 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 502 and/or the computing device 524 can be connected to a computing resources provider 528 via the network 522 using a network interface such as those described herein (e.g., network interface 520). In such embodiments, one or more systems (e.g., service 530 and service 532) hosted within the computing resources provider 528 (also referred to herein as within “a computing resources provider environment”) may execute one or more services to perform one or more functions under the control of, or on behalf of, programs and/or services operating on computing device 502 and/or computing device 524. Systems such as service 530 and service 532 may include one or more computing devices such as those described herein to execute computer code to perform the one or more functions under the control of, or on behalf of, programs and/or services operating on computing device 502 and/or computing device 524.

For example, the computing resources provider 528 may provide a service, operating on service 530 to store data for the computing device 502 when, for example, the amount of data that the computing device 502 exceeds the capacity of storage device 510. In another example, the computing resources provider 528 may provide a service to first instantiate a virtual machine (VM) on service 532, use that VM to access the data stored on service 532, perform one or more operations on that data, and provide a result of those one or more operations to the computing device 502. Such operations (e.g., data storage and VM instantiation) may be referred to herein as operating “in the cloud,” “within a cloud computing environment,” or “within a hosted virtual machine environment,” and the computing resources provider 528 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 528 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, combinations thereof, or the like. Various techniques to facilitate such services include, but are not limited to, virtual machines, virtual storage, database services, system schedulers (e.g., hypervisors), resource management systems, various types of short-term, mid-term, long-term, and archival storage devices, etc.

As may be contemplated, the systems such as service 530 and service 532 may implement versions of various services (e.g., the service 512 or the service 526) on behalf of, or under the control of, computing device 502 and/or computing device 524. Such implemented versions of various services may involve one or more virtualization techniques so that, for example, it may appear to a user of computing device 502 that the service 512 is executing on the computing device 502 when the service is executing on, for example, service 530. As may also be contemplated, the various services operating within the computing resources provider 528 environment may be distributed among various systems within the environment as well as partially distributed onto computing device 524 and/or computing device 502.

The following examples illustrate various aspects of the present disclosure. As used below, any reference to a series of examples is to be understood as a reference to each of those examples disjunctively (e.g., “Examples 1-4” is to be understood as “Examples 1, 2, 4, or 4”).

Example 1 is a method comprising: detecting, during a presentation of a media segment, instructions associated with a current context being presented by the media segment; executing, based on the instructions, a request for an acquisition protocol for an object corresponding to the current context, wherein the request includes an identification of the object and a user associated with the presentation of the media segment, wherein the acquisition protocol is configured to enable access to an instance of the object; receiving the acquisition protocol; and facilitating a presentation of the acquisition protocol next to the presentation of the media segment.

Example 2 is the method of example(s) 1, wherein the instructions are embedded into the media segment.

Example 3 is the method of example(s) 1, wherein the instructions are embedded into a webpage, and wherein the media segment is being presented in a portion of the webpage.

Example 4 is the method of example(s) 1, wherein the instructions are configured to execute when the object is referenced within the media segment.

Example 5 is the method of example(s) 4, wherein the object is referenced over an audio channel of the media segment.

Example 6 is the method of example(s) 4, wherein the object is referenced over a video channel of the media segment.

Example 7 is the method of example(s) 1, wherein executing the request for the acquisition protocol for the object corresponding to the context includes executing an application programming interface function call to a remote computing device.

Example 8 is the method of example(s) 1, wherein the acquisition protocol is configured for execution during presentation of the media segment.

Example 9 is a system comprising: one or more processors; and a non-transitory computer-readable medium storing instructions that when executed by the one or more processors, cause the one or more processors to perform the methods of any of example(s)s 1-8.

Example 10 is a non-transitory computer-readable medium storing instructions that when executed by one or more processors, cause the one or more processors to perform the methods of any of example(s)s 1-8.

Client devices, computing devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a keypad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 902) include, but is not limited to, desktop computers, laptop computers, server computers, hand-held computers, tablets, smart phones, personal digital representatives, digital home representatives, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein. Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example process of FIG. 4). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general-purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital representative (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 602.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claims.

1. A method comprising:
detecting, during a presentation of a media segment, instructions associated with a current context being presented by the media segment;
executing, based on the instructions, a request for an acquisition protocol for an object corresponding to the current context, wherein the request includes an identification of the object and a user associated with the presentation of the media segment, wherein the acquisition protocol is configured to enable access to an instance of the object;
receiving the acquisition protocol; and
facilitating a presentation of the acquisition protocol next to the presentation of the media segment.

2. The method of claim 1, wherein the instructions are embedded into the media segment.

3. The method of claim 1, wherein the instructions are embedded into a webpage, and wherein the media segment is being presented in a portion of the webpage.

4. The method of claim 1, wherein the instructions are configured to execute when the object is referenced within the media segment.

5. The method of claim 4, wherein the object is referenced over an audio channel of the media segment.

6. The method of claim 4, wherein the object is referenced over a video channel of the media segment.

7. The method of claim 1, wherein executing the request for the acquisition protocol for the object corresponding to the current context includes executing an application programming interface function call to a remote computing device.

8. A system comprising:
one or more processors; and
a non-transitory computer-readable medium storing instructions that when executed by the one or more processors, cause the one or more processors to perform operations including:
detecting, during a presentation of a media segment, instructions associated with a current context being presented by the media segment;
executing, based on the instructions, a request for an acquisition protocol for an object corresponding to the current context, wherein the request includes an identification of the object and a user associated with the presentation of the media segment, wherein the acquisition protocol is configured to enable access to an instance of the object;
receiving the acquisition protocol; and
facilitating a presentation of the acquisition protocol next to the presentation of the media segment.

9. The system of claim 8, wherein the instructions are embedded into the media segment.

10. The system of claim 8, wherein the instructions are embedded into a webpage, and wherein the media segment is being presented in a portion of the webpage.

11. The system of claim 8, wherein the instructions are configured to execute when the object is referenced within the media segment.

12. The system of claim 11, wherein the object is referenced over an audio channel of the media segment.

13. The system of claim 11, wherein the object is referenced over a video channel of the media segment.

14. The system of claim 8, wherein executing the request for the acquisition protocol for the object corresponding to the current context includes executing an application programming interface function call to a remote computing device.

15. A non-transitory computer-readable medium storing instructions that when executed by one or more processors, cause the one or more processors to perform operations:
detecting, during a presentation of a media segment, instructions associated with a current context being presented by the media segment;
executing, based on the instructions, a request for an acquisition protocol for an object corresponding to the current context, wherein the request includes an identification of the object and a user associated with the presentation of the media segment, wherein the acquisition protocol is configured to enable access to an instance of the object;
receiving the acquisition protocol; and
facilitating a presentation of the acquisition protocol next to the presentation of the media segment.

16. The non-transitory computer-readable medium of claim 15, wherein the instructions are embedded into the media segment.

17. The non-transitory computer-readable medium of claim 15, wherein the instructions are embedded into a webpage, and wherein the media segment is being presented in a portion of the webpage.

18. The non-transitory computer-readable medium of claim 15, wherein the instructions are configured to execute when the object is referenced within the media segment.

19. The non-transitory computer-readable medium of claim 18, wherein the object is referenced over an audio channel or a video channel of the media segment.

20. The non-transitory computer-readable medium of claim 15, wherein executing the request for the acquisition protocol for the object corresponding to the current context includes executing an application programming interface function call to a remote computing device.
